(19) United States
(12) Patent Application Publication
(10) Pub. No.: US 2026/0278844 A1
(43) Pub. Date: Sep. 17, 2026

(54) COMPRESSED-DOMAIN MULTI-FRAME PROCESSING

(71) Applicant: Samsung Electronics Co., Ltd., Suwon-si (KR)

(72) Inventors: Chengyu Wang, Plano, TX (US); Pavan C. Madhusudanarao, Redmond, WA (US); Jing Li, Allen, TX (US); Hamid Rahim Sheikh, Allen, TX (US); John Seokjun Lee, Allen, TX (US)

(21) Appl. No.: 19/304,430

(22) Filed: Aug. 19, 2025

Related U.S. Application Data
(60) Provisional application No. 63/771,439, filed on Mar. 13, 2025.

(51) Int. Cl. G06T 9/00; G06T 3/18; G06T 3/40; G06T 5/50; G06T 7/20; G06V 10/28; G06V 10/771

(52) U.S. Cl. CPC G06T 9/00; G06T 3/18; G06T 3/40; G06T 5/50; G06T 7/20; G06V 10/28; G06V 10/771; G06T 2207/20208

(57) ABSTRACT

A method includes obtaining, using at least one processing device of an electronic device, multiple input frames in a raw image space. The method also includes compressing, using the at least one processing device, the input frames to generate corresponding input latent feature sets in a latent space. The method further includes performing, using the at least one processing device, multi-frame processing using the input latent feature sets to generate an output latent feature set in the latent space. In addition, the method includes decompressing, using the at least one processing device, the output latent feature set to generate an output frame in a pixel space.

### CROSS-REFERENCE TO RELATED APPLICATION AND PRIORITY CLAIM

This application claims priority under 35 U.S.C. § 119 (e) to U.S. Provisional Patent Application No. 63/771,439 filed on Mar. 13, 2025, which is hereby incorporated by reference in its entirety.

### TECHNICAL FIELD

This disclosure relates generally to image processing systems. More specifically, this disclosure relates to compressed-domain multi-frame image processing.

### BACKGROUND

Multi-frame processing (MFP) is commonly used in modern mobile device camera systems. For example, mobile device cameras can be used to capture multiple image frames of a scene with the same or different exposure values (EVs), and an MFP algorithm can analyze the image frames and jointly process and blend the image frames to create a single output image. Example operations in an MFP pipeline can include single frame demosaicing, multi-frame registration, high dynamic range (HDR) blending, deghosting, and blending. Using these operations, the MFP pipeline can generate output images with less noise, better details, and higher dynamic range as compared to single images captured by the mobile device cameras.

### SUMMARY

This disclosure relates to compressed-domain multi-frame image processing.

In a first embodiment, a method includes obtaining, using at least one processing device of an electronic device, multiple input frames in a raw image space. The method also includes compressing, using the at least one processing device, the input frames to generate corresponding input latent feature sets in a latent space. The method further includes performing, using the at least one processing device, multi-frame processing using the input latent feature sets to generate an output latent feature set in the latent space. In addition, the method includes decompressing, using the at least one processing device, the output latent feature set to generate an output frame in a pixel space.

In a second embodiment, an electronic device includes at least one processing device configured to obtain multiple input frames in a raw image space. The at least one processing device is also configured to compress the input frames to generate corresponding input latent feature sets in a latent space. The at least one processing device is further configured to perform multi-frame processing using the input latent feature sets to generate an output latent feature set in the latent space. In addition, the at least one processing device is configured to decompress the output latent feature set to generate an output frame in a pixel space.

Any single one or any combination of the following features may be used with the first or second embodiment.

The input frames may be compressed by encoding, using a machine learning model, the input frames to generate the corresponding input latent feature sets in the latent space. Each input latent feature set may include multiple input latent feature subsets. For each input latent feature set, each of the input latent feature subsets may have a different spatial dimension and may include multiple feature maps having the spatial dimension of the subset.

The input latent feature subsets may include continuous input latent feature subsets, and the latent space may include a continuous latent space. Each input latent feature set may be compressed to generate a corresponding discrete input latent feature set in a discrete latent feature space by quantizing each of the continuous input latent feature subsets using a corresponding quantization codebook to generate a corresponding discrete input latent feature subset in the discrete latent feature space. Before the multi-frame processing is performed, each discrete input latent feature set may be decompressed to generate the corresponding input latent feature set by de-quantizing each of the discrete input latent feature subsets using the corresponding quantization codebook to generate the corresponding continuous input latent feature subset in the continuous latent space.

The output latent feature set may include multiple output latent feature subsets, and each output latent feature subset may have a different spatial dimension and may include multiple feature maps having the spatial dimension of the subset. The output latent feature set may be decompressed by decoding, using the machine learning model, the output latent feature subsets to generate the output frame in the pixel space. In some cases, the input frames may have a first resolution, and the output latent feature set may be decompressed by decoding, using the machine learning model, the output latent feature subsets to generate the output frame in the pixel space at the first resolution. In other cases, the output latent feature set may be decompressed by decoding, using the machine learning model, some of the output latent feature subsets to generate the output frame in the pixel space at a second resolution, and the second resolution may be lower than the first resolution.

The multi-frame processing in the latent space may be performed by (i) performing registration on the input latent feature sets in the latent space to generate registered feature sets and (ii) performing, using a second machine learning model, deghosting on the registered feature sets in the latent space to generate a blended feature set. The registration may be performed by (i) selecting a reference feature map from one of the input latent feature sets that corresponds to a reference frame of the input frames and (ii) for each other input latent feature set, (a) selecting a feature map having a spatial dimension that matches a spatial dimension of the reference feature map, (b) generating a warping matrix from the selected feature map and the reference feature map, and (c) warping each feature map of the input latent feature subsets using the warping matrix.

Each registered feature set may include multiple registered feature subsets. The deghosting may be performed by (i) estimating, using the second machine learning model based on at least some of the registered feature subsets having highest spatial dimensions from each of the registered feature sets, a deghosting motion map that indicates portions of the registered feature sets in which there is motion between the input frames and (ii) for each spatial dimension of the registered feature subsets, scaling the deghosting motion map to that spatial dimension and performing deghosting blending on the registered feature subsets having that spatial dimension according to the scaled deghosting blending map to generate a deghosted feature subset having that spatial dimension. The blended feature set may include the deghosted feature subsets.

Each of the multiple input frames may be captured with a different EV, and the input frame captured with the highest EV may be a reference frame. The multi-frame processing in the latent space may be performed by (i) selecting a reference feature map from one of the input latent feature sets that corresponds to the reference frame, (ii) generating a saturation map that indicates portions of the reference feature map in which saturation is above a specified threshold, and (iii) for each spatial dimension of the deghosted feature subsets, scaling the saturation map to that spatial dimension and performing HDR blending on the deghosted feature subsets having that spatial dimension according to the scaled saturation map to generate an HDR blended feature subset having that spatial dimension.

A non-transitory machine-readable medium may contain instructions that when executed cause at least one processor of an electronic device to perform the method of the first embodiment, optionally with any one or any combination of the features described above.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example compressed-domain multi-frame image processing system in accordance with this disclosure;

FIG. 3 illustrates an example image multi-frame processing (MFP) pipeline in accordance with this disclosure;

FIG. 4 illustrates an example improved MFP pipeline in accordance with this disclosure;

FIG. 5 illustrates an example compression system in accordance with this disclosure;

FIG. 6 illustrates an example compression system with progressive encoding in accordance with this disclosure;

FIG. 7 illustrates an example compression system with quantization in accordance with this disclosure;

FIG. 8 illustrates an example compression system for high dynamic range (HDR) processing in accordance with this disclosure;

FIG. 9 illustrates another example MFP pipeline in accordance with this disclosure;

FIG. 10 illustrates an example image registration operation in accordance with this disclosure;

FIG. 11 illustrates an example deghosting analysis operation in accordance with this disclosure;

FIG. 12 illustrates an example deghosting blending operation in accordance with this disclosure;

FIG. 13 illustrates an example HDR analysis operation in accordance with this disclosure;

FIG. 14 illustrates an example HDR blending operation in accordance with this disclosure;

FIGS. 15A-15B illustrate an example comparison between an image generated without image registration and an image generated with image registration in the compressed domain in accordance with this disclosure;

FIGS. 16A-16B illustrate an example comparison of ghosting artifacts between an image generated without deghosting and an image generated with deghosting in the compressed domain in accordance with this disclosure;

FIGS. 17A-17B illustrate an example comparison of noise between an image generated without multi-frame blending and an image generated with multi-frame blending in the compressed domain in accordance with this disclosure;

FIGS. 18A-18B illustrate an example comparison between an image generated without HDR blending and an image generated with HDR blending in the compressed domain in accordance with this disclosure;

FIGS. 19A-19C illustrate an example comparison between an image generated after encoding, an image generated after encoding with quantization, and a ground truth image in accordance with this disclosure; and

FIG. 20 illustrates an example method for compressed-domain multi-frame image processing in accordance with this disclosure.

### DETAILED DESCRIPTION

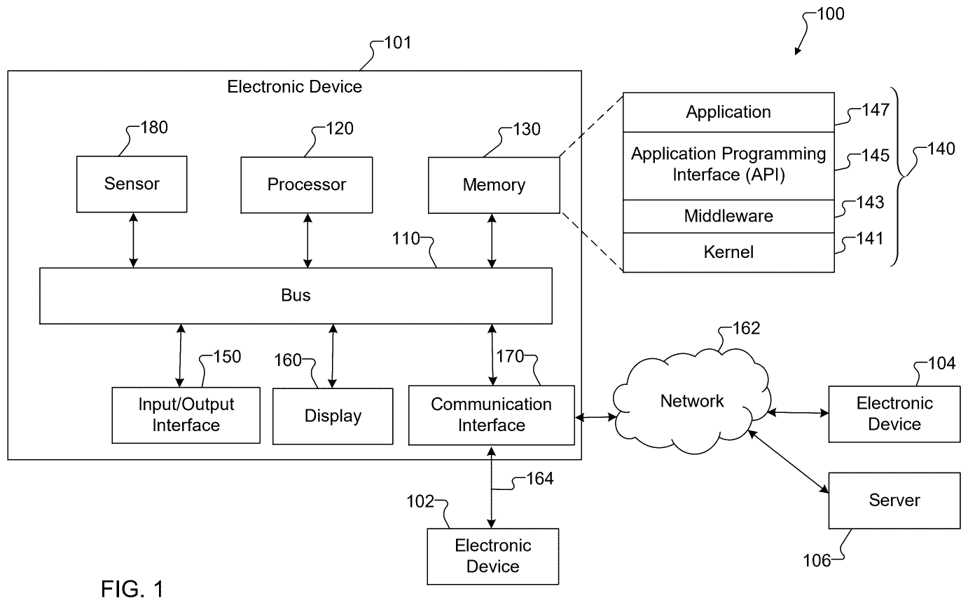

FIGS. 1 through 20, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, multi-frame processing (MFP) is commonly used in modern mobile device camera systems. For example, mobile device cameras can be used to capture multiple image frames of a scene with the same or different exposure values (EVs), and an MFP algorithm can analyze the image frames and jointly process and blend the image frames to create a single output image. Example operations in an MFP pipeline can include single frame demosaicing, multi-frame registration, high dynamic range (HDR) blending, deghosting, and blending. Using these operations, the MFP pipeline can generate output images with less noise, better details, and higher dynamic range as compared to single images captured by the mobile device cameras. Unfortunately, current MFP pipelines may require significant computing and memory resources. While mobile devices now include higher-resolution cameras, higher-resolution MFP is challenging due to the computational demands and memory consumption associated with higher-resolution images.

This disclosure provides various techniques for compressed-domain multi-frame image processing. As described in more detail below, multiple input frames in a raw image space can be obtained, and the input frames can be compressed to generate corresponding input latent feature sets in a latent space. Multi-frame processing can be performed using the input latent feature sets to generate an output latent feature set in the latent space, and the output latent feature set can be decompressed to generate an output frame in a pixel space. This disclosure also provides techniques for further compressing the latent feature sets into a discrete latent space for storage before or after processing.

In this way, embodiments of this disclosure enable mapping input frames into a compressed domain, generating a compressed-domain representation of a blended output frame based on the compressed-domain representations of the input frames, and reconstructing a blended image frame in an image domain from the corresponding compressed-domain representation. In some cases, artificial intelligence (AI)/machine learning (ML) models that are trained to operate on compressed-domain representations (such as latent feature sets) of image frames may be used. Overall, these approaches can provide improved blended image generation using efficient and effective compressed-domain image processing.

Note that while various embodiments of this disclosure are described in the context of use in consumer electronic devices (such as smartphones), this is merely one example. It will be understood that the principles of this disclosure may be implemented in any number of other suitable contexts and may use any suitable device or devices. Further, note that while some embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to compressed-domain multi-frame image processing.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform compressed-domain multi-frame image processing. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to compressed-domain multi-frame image processing.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

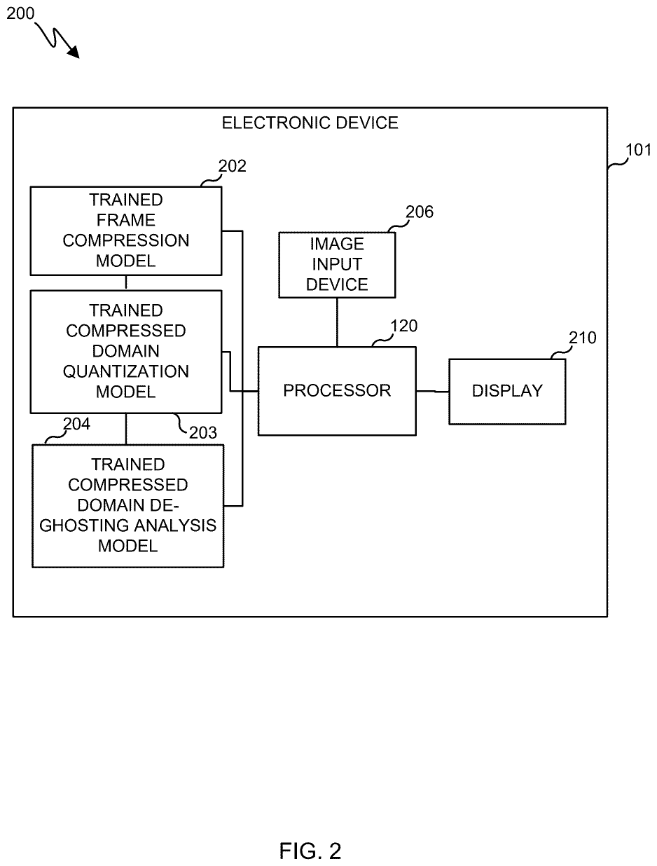

FIG. 2 illustrates an example compressed-domain multi-frame image processing system 200 in accordance with this disclosure. For ease of explanation, the system 200 is described as being implemented using the electronic device 101 in the network configuration 100 of FIG. 1. However, the system 200 may be used with any other suitable device(s), such as the server 106, and in any other suitable system(s).

As shown in FIG. 2, the system 200 includes the processor 120, which is operatively coupled to or otherwise configured to use one or more machine learning models, such as a frame compression model 202, a compressed-domain quantization model 203, and a compressed-domain deghosting analysis model 204. Each of these models 202-204 represents any suitable AI/ML model that can be trained to perform the functions described below. Each of these models 202-204 can also have any suitable AI/ML architecture.

The frame compression model 202 represents a model that can be trained to extract latent features (in a latent space or compressed domain) from raw image data of full-resolution image frames (in a raw image space or image domain), generating a compressed-domain representation or latent feature set for each image frame. In some embodiments, the frame compression model 202 can represent a U-net convolutional network. The frame compression model 202 can additionally be trained to reconstruct an image in a pixel space (in the image domain) from an output latent feature set (obtained through compressed-domain multi-frame processing of the latent feature sets for each input frame) to create a blended output frame.

The compressed-domain quantization model 203 represents a model that can be trained to map continuous latent features of a latent feature set into a discrete latent space (in the compressed domain), generating a quantized latent feature set for each frame. In some embodiments, the compressed-domain quantization model 203 can represent a vector quantization variational auto-encoder (VQ-VAE) network. The compressed-domain deghosting analysis model 204 represents a model that can be trained to estimate a deghosting (or motion) map in the compressed domain. The estimated deghosting map may be used to perform deghosting blending in the compressed domain (as part of the multi-frame processing of the latent feature sets).

In some embodiments, these models 202-204 can be jointly trained, meaning the parameters of all models 202-204 can be adjusted during the training. Also, in some embodiments, the models 202-204 can be stored in a memory of the electronic device 101 (such as the memory 130) and accessed by the processor 120 of the electronic device 101 to perform compressed-domain multi-frame image processing or other tasks. In other embodiments, one or more of the models 202-204 can be stored in any other suitable manner, such as when one or more of the models 202-204 are stored remotely from the electronic device 101 (such as in the server 106). In these embodiments, the electronic device 101 can transmit requests including inputs (such as captured raw frame data or other data) to the server 106 for processing of the inputs using one or more machine learning models, and the results can be sent back to the electronic device 101.

The system 200 also includes an image input device 206 (such as one or more cameras or other imaging sensors 180) and a display 210 (such as a screen or monitor like the display 160). Here, the processor 120 can receive raw image frames from the image input device 206 and provide the image frames to the trained frame compression model 202. The trained frame compression model 202 can extract latent features for each input frame in a latent space and output latent feature sets to the processor 120. The processor 120 can provide the latent feature sets to the trained compressed-domain quantization model 203, which can map the continuous latent feature sets into a discrete latent space for storage and map the discrete latent feature sets back into the continuous latent space for further image processing. The processor 120 can provide the latent feature sets to the compressed-domain deghosting analysis model 204, which can generate an estimated deghosting map in the latent space. The estimated deghosting map may be used for deghosting analysis in the latent space.

Although FIG. 2 illustrates one example of a compressed-domain multi-frame image processing system 200, various changes may be made to FIG. 2. For example, various components, operations, or functions in FIG. 2 may be combined, further subdivided, replicated, omitted, or rearranged and additional components, operations, or functions may be added according to particular needs. Also, depending on the implementation, the models 202-204 may be stored as separate models called upon by the processor 120 to perform certain tasks or may be included in or form at least a part of one or more larger machine learning models.

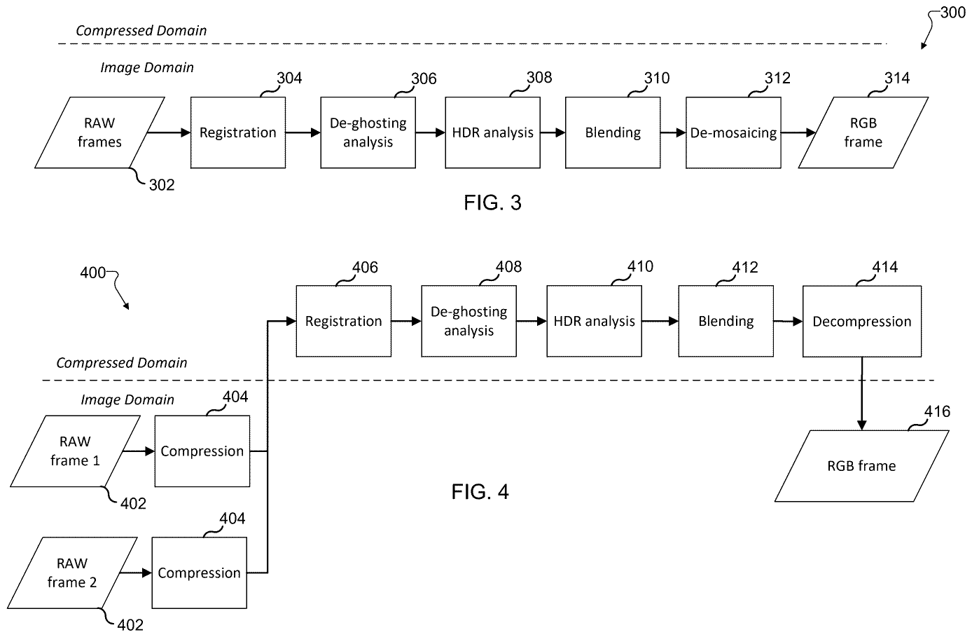

FIG. 3 illustrates an example MFP pipeline 300 in accordance with this disclosure. As shown in FIG. 3, all processing occurs in the pixel domain. That is, the MFP pipeline 300 takes the data of multiple raw input frames 302 and performs multi-frame registration 304, deghosting analysis 306 (such as motion analysis), HDR analysis 308, blending 310, and demosaicing 312 using the full raw frame data to generate an output RGB frame 314 in the pixel domain (such as in a color space like the RGB color space). The MFP procedures store all of the image data in memory. However, for high resolution imaging (such as 200 megapixel (MP) imaging), it is not feasible to store the full image data of multiple frames in memory. This makes it difficult to provide a high-quality image with MFP. Reducing the volume of the image data can be useful or important to enable MFP for high-resolution images. Additionally, the power consumption of the MFP pipeline also increases with the input image resolution due to increased computational load, so reducing the required computations can be useful or important to enable MFP for high-resolution images.

Embodiments of this disclosure efficiently perform MFP in the compressed domain. These embodiments reduce the computational load and memory requirements of an MFP pipeline.

FIG. 4 illustrates an example improved MFP pipeline 400 in accordance with this disclosure. For ease of explanation, the MFP pipeline 400 is described as being implemented using the electronic device 101 in the network configuration 100 of FIG. 1. However, the MFP pipeline 400 may be used with any other suitable device(s), such as the server 106, and in any other suitable system(s).

As shown in FIG. 4, part of the processing in the MFP pipeline 400 occurs in the compressed domain. In this example, the MFP pipeline 400 obtains full-resolution image data in the image domain (such as a raw image space) for multiple raw input frames 402, compresses the raw data, processes the compressed data, and decompresses the processed data to generate an output RGB frame 416 in the image domain (such as a three-channel color space or pixel space). In some embodiments, AI/ML models are used in the MFP pipeline 400. For example, an AI/ML-based compression model (such as the model 202) may perform compression 404 of the raw frames 402 into the compressed domain (such as a latent space). An AI/ML-based motion estimation model (such as the model 204) may be used for deghosting analysis 408 in the latent space. HDR analysis 410 and blending 412 can be performed in the latent space, and an AI/ML-based decompression model (such as the model 202) may perform decompression 414 on the blending result to generate the RGB frame 416 in the pixel space. The various operations 406-412 here are performed in the compressed domain and therefore can involve significantly lower computational and memory resources than the corresponding image-domain operations of FIG. 3.

Additionally, the latent space may be a continuous latent space, and an AI/ML-based quantization model (such as the model 203) may perform further compression of the results from any of the operations 406-412 into a discrete latent space. This quantization may be used to reduce memory resources needed for storage of results between any of the operations 406-412. An AI/ML-based quantization model (such as the model 203) may also perform decompression from the discrete latent space back into the continuous latent space (such as the compressed domain) before further operations are performed.

The MFP pipeline 400 here can therefore be generally described with respect to two elements, namely (i) a compression technique for compressing pixel-domain raw frames into a compressed domain and (ii) multi-frame analysis and blending operations in the compressed domain. In some embodiments, the compression technique may target a “3×” compression ratio and can map raw data of the input frames from a raw image space of the image domain to a latent space, resulting in latent space representations (such as latent feature sets) of the input frames having roughly one-third the size of the raw input frames. The registration, deghosting analysis, HDR analysis, and blending operations operate on the latent space representations, thereby generating a latent space representation (such as a latent feature set) corresponding to a blended output frame. A corresponding decompression technique can reconstruct an output frame in a pixel space (such as a color space) of the image domain from the blended latent feature set.

Although FIG. 4 illustrates one example of an improved MFP pipeline 400, various changes may be made to FIG. 4. For example, various components, operations, or functions in FIG. 4 may be combined, further subdivided, replicated, omitted, or rearranged and additional components, operations, or functions may be added according to particular needs. As a specific example, any number of raw frames 402 may be input to the MFP pipeline 400 for processing in order to produce any number of output frames. Also, while specific color spaces like RGB are described above, image data in any other suitable color space(s) may be used.

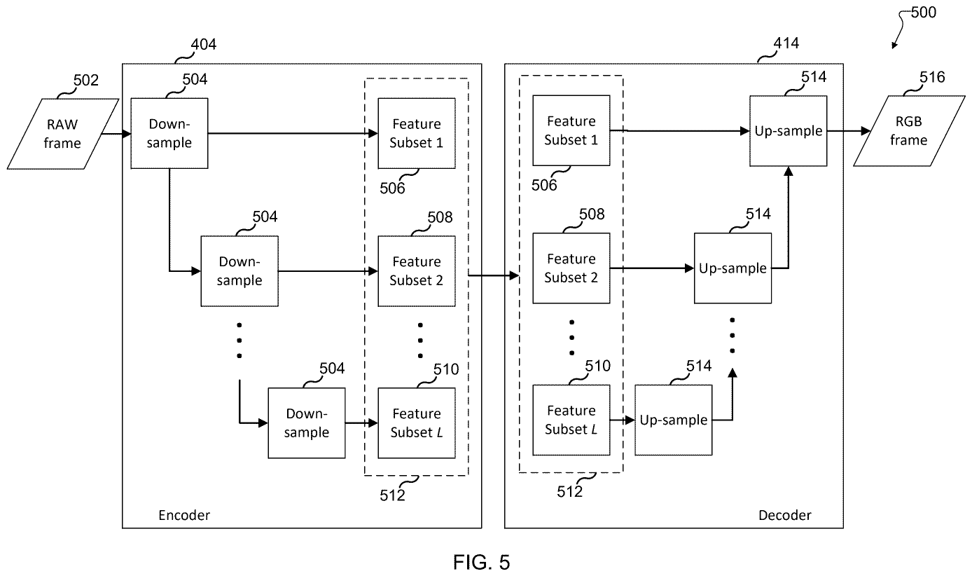

FIG. 5 illustrates an example compression system 500 in accordance with this disclosure. The compression system 500 may, for example, be used to implement the compression 404 and decompression 414 of FIG. 4. In this example, the compression system 500 uses an encoder/decoder AI/ML model (or neural network). The encoder/decoder in this example adopts the U-net structure. The encoder encodes single-channel raw image data into latent features for use in downstream processing in the compressed domain, and the decoder reconstructs a three-channel image in a pixel space (such as an RGB color space in the image domain) from latent features. The latent features are generated in multiple spatial scales and may be referred to as a multiscale latent feature set.

As shown in FIG. 5, the encoder in the U-net (corresponding to compression 404) includes a network of L down-sampling layers 504. In some cases, the down-sampling layers 504 may be implemented as convolutional layers. Each down-sampling layer 504 outputs a latent feature subset, such as a three-dimensional (3D) matrix, with progressively lower spatial dimensions. For example, given an input having spatial dimensions M×N, the latent feature subsets may have spatial dimensions of M/2×N/2, M/4×N/4, M/8×N/8, and so on. Each 3D matrix can contain multiple two-dimensional (2D) matrices that have the spatial dimension of the latent feature subset, and each 2D matrix can represent a latent feature map. The 3D matrix of the latent feature subset represents the latent features of the image extracted by the encoder. Accordingly, latent feature subsets are a representation of the input image data in a latent space (which may be referred to as a feature space).

The first down-sampling layer 504 takes in raw frame data 502 (such as a raw frame 402) and generates a first feature subset 506 with lower spatial dimensions than the input data. The next down-sampling layer 504 takes in the feature subset 506 and generates a second feature subset 508 with lower spatial dimensions than feature subset 506. This pattern is repeated until the final (Lth) down-sampling layer 504 generates the final (Lth) feature subset 510 with the lowest spatial dimensions of the L feature subsets. Together, the feature subsets form a multiscale latent feature set 512 in the latent space.

The decoder in the U-net (corresponding to decompression 414) includes a network of L up-sampling layers 514. In some cases, the up-sampling layers 514 may be implemented as convolutional layers. The decoder takes in a multiscale latent feature set 512 including L feature subsets having different spatial dimensions. The multiscale latent feature set 512 provided to the decoder may be the result of processing by an MFP pipeline (such as by operations 406-412 of MFP pipeline 400).

The first up-sampling layer 514 takes in the feature subset 510 with the lowest spatial dimensions, up-samples it, and passes the result to the next up-sampling layer. Each subsequent up-sampling layer 514 takes in the up-sampled output from the layer below, combines it with the feature subset having the next lowest spatial dimension, up-samples the combination, and passes the result to the next up-sampling layer. The final up-sampling layer 514 outputs an RGB frame 516, which is an image in a three-channel pixel space (in this case, the RGB color space) in the image domain.

Table 1 illustrates spatial dimensions for one example embodiment of the encoder/decoder network of FIG. 5. In this example, the encoder and decoder each have L=7 layers, and the multiscale latent feature set 512 includes L=7 feature subsets.

TABLE 1

| Input Frame | Latent Feature Subsets |
|---|---|
| 512 × 512 × 1 | 256 × 256 × 32 |
| | 128 × 128 × 64 |
| | 64 × 64 × 128 |
| | 32 × 32 × 256 |
| | 16 × 16 × 512 |
| | 8 × 8 × 512 |
| | 4 × 4 × 512 |

In the example of Table 1, the raw frame 502 has spatial dimensions of 512×512 with a single data channel. Each latent feature subset has its spatial dimensions down-sampled by a factor of two (such as from 512×512 to 256×256, and so on). Each latent feature subset also has multiple feature channels (such as 32 feature channels, 64 feature channels, and so on), where each feature channel represents a feature map. The higher-layer latent feature subsets contain more information about image details, while the lower-layer latent feature sets contain more information about the low-frequency structure of the image.

Although FIG. 5 illustrates one example of a compression system 500, various changes may be made to FIG. 5. For example, various components, operations, or functions in FIG. 5 may be combined, further subdivided, replicated, omitted, or rearranged and additional components, operations, or functions may be added according to particular needs. Also, while specific color spaces like RGB are described above, image data in any other suitable color space(s) may be used.

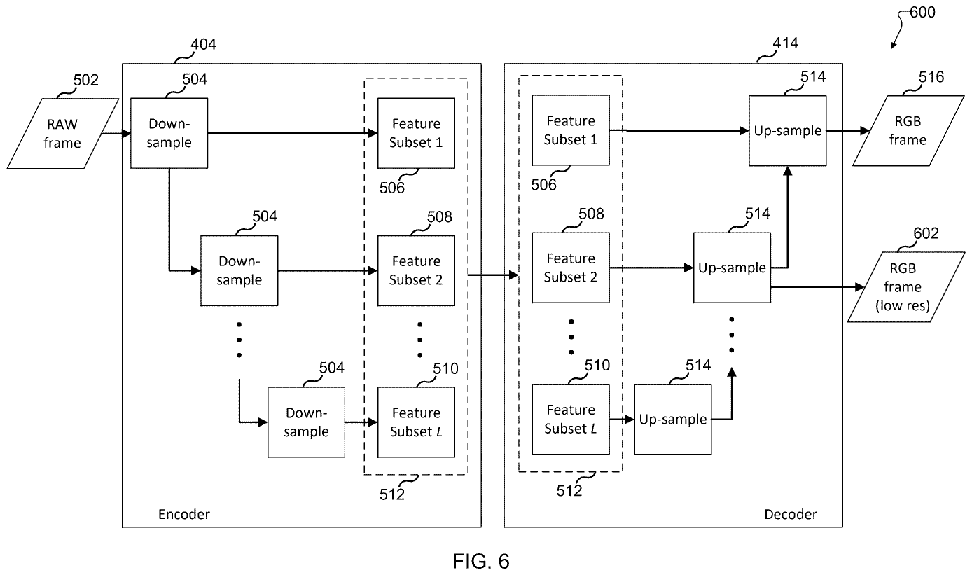

FIG. 6 illustrates an example compression system 600 with progressive encoding in accordance with this disclosure. The compression system 600 is a modification of the compression system 500 of FIG. 5 to include a progressive encoding feature. This allows low-resolution RGB images 602 to be generated from partial feature sets when full-resolution images are not needed, resulting in further savings of computational and memory resources.

In the example of FIG. 6, the compression system 600 differs from the compression system 500 of FIG. 5 by the addition of a convolution layer to the penultimate up-sampling layer. This allows the compression system 600 to skip the last up-sampling layer and generate a low-resolution RGB frame 602 (such as a three-channel image in the RGB color space).

Although FIG. 6 illustrates one example of a compression system 600 with progressive encoding, various changes may be made to FIG. 6. For example, various components, operations, or functions in FIG. 6 may be combined, further subdivided, replicated, omitted, or rearranged and additional components, operations, or functions may be added according to particular needs. Also, while specific color spaces like RGB are described above, image data in any other suitable color space(s) may be used.

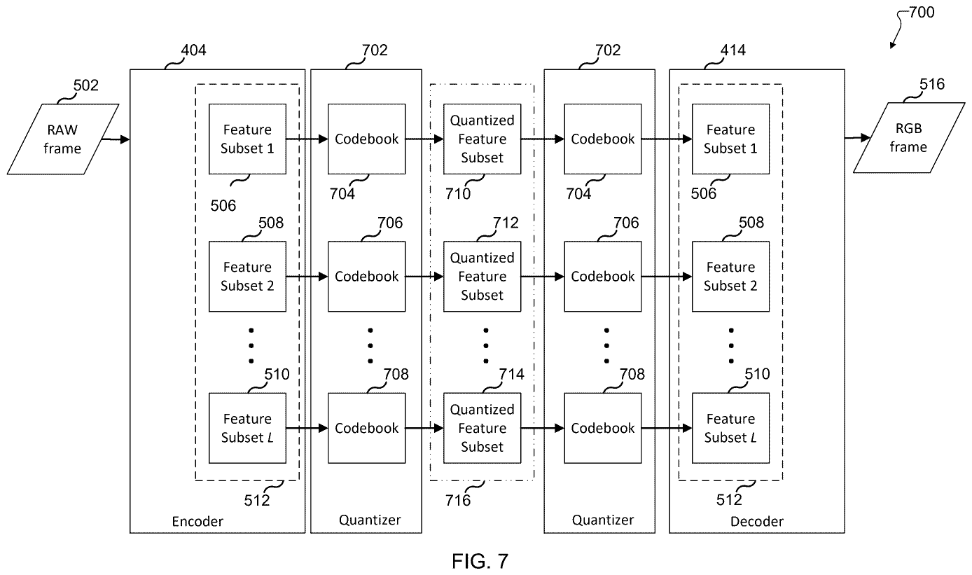

FIG. 7 illustrates an example compression system 700 with quantization in accordance with this disclosure. The compression system 700 may, for example, be used to implement compression 404 and decompression 414 of FIG. 4. The compression system 700 is an extension of the compression system 500 with an added quantizer 702. In this example the quantizer 702 performs vector quantization. However, it will be understood that other quantization methods, such as finite scalar quantization or residual quantization, may be used here.

Vector quantization compresses the continuous latent feature set 512 further by approximating the continuous 3D latent feature subsets with discrete 2D index maps based on a codebook of embedding vectors. For multiscale latent feature sets, a separate codebook (such as a codebook 704, 706, 708, etc.) is trained for each of the L feature subsets (such as the feature subsets 506, 508, 510, etc.). A feature vector corresponds to each spatial location in the 3D feature subset. For each such feature vector, the quantizer 702 determines the index i of the nearest matching codebook vector et, such as with respect to mean squared error (MSE). The determined index i represents that feature vector in the discrete latent space. The quantizer 702 repeats this process for each feature vector of the feature subset to generate a 2D index map of the indices representing each feature vector. This index map may be referred to as a quantized feature subset (such as quantized feature subsets 710, 712, 714).

Using the example values from Table 1 above, the highest-level latent feature subset 506 has a size of 256×256×32. Using a corresponding codebook 704 that has 1,024 embedding vectors eᵢ∈R³² (that is, the vectors have dimensionality D=32), the 256×256×32 feature subset is quantized to a 256×256 index map in the discrete latent space, and each element of the index map can be an integer index i∈[1,1024]. This index map constitutes the quantized feature subset 710 and takes fewer bits to store as compared to the 3D latent feature subset 506.

When image processing is needed, the quantized feature subsets can be dequantized using the corresponding codebooks for downstream processing tasks, since image processing can occur in the feature domain (that is, the continuous latent space). As illustrated in FIG. 7, the quantizer 702 may perform both quantization and dequantization since the same codebooks can be applied for both procedures.

In some embodiments, the AI/ML model that implements the encoder (corresponding to compression 404) and decoder (corresponding to decompression 414) and the AI/ML model that implements the quantizer 702 of the compression system 700 may be jointly trained, which can achieve improved or optimal performance. During the training, the codebooks can be learned, such as by fitting all training data, so that the codebooks give a reduced or minimum error for the entire training data.

The compression ratio provided by the quantizer 702 can be controlled based on the size of the codebooks, meaning the number of embedding vectors in the codebooks. A larger codebook reduces the quantization error, resulting in more accurate reconstruction during dequantization. However, when the codebook has more vectors, the number of bits used to store the index of the matrix increases, and the compression ratio decreases. Since the higher-layer feature subsets contain more important information about the image, larger codebooks may be used to quantize the higher layer feature subsets, while smaller codebooks may be used to quantize the lower-layer feature subsets. The resulting decrease in reconstruction accuracy from the lower layer feature subsets can have a relatively low impact that may justify the saved storage space. Table 2 illustrates an example of different codebook sizes.

TABLE 2

| | | | Codebooks |
|---|---|---|---|
| | Latent Feature | | (embedding |
| Input Frame | Subsets | Index Maps | vectors/bits) |
| 512 × 512 × 1 | 256 × 256 × 32 | 256 × 256 | 2048/11 |
| | 128 × 128 × 64 | 128 × 128 | 2048/11 |
| | 64 × 64 × 128 | 64 × 64 | 2048/11 |
| | 32 × 32 × 256 | 32 × 32 | 1024/10 |
| | 16 × 16 × 512 | 16 × 16 | 1024/10 |
| | 8 × 8 × 512 | 8 × 8 | 1024/10 |
| | 4 × 4 × 512 | 4 × 4 | 1024/10 |

In the example of Table 2, the three highest-layer feature subsets have codebooks with 2,048 embedding vectors, which use eleven bits to represent the vector index in the associated index map. The remaining feature subsets have smaller codebooks with only 1,024 embedding vectors, which use only ten bits to represent the vector index in the associated index map. After vector quantization according to Table 2, the discrete latent space representation of each pixel is represented by 3.66 bits, while each pixel of raw data is represented by twelve bits. The compression ratio of this vector quantization scheme is thus 3.28.

Although FIG. 7 illustrates one example of a compression system 700 with quantization, various changes may be made to FIG. 7. For example, various components, operations, or functions in FIG. 7 may be combined, further subdivided, replicated, omitted, or rearranged and additional components, operations, or functions may be added according to particular needs.

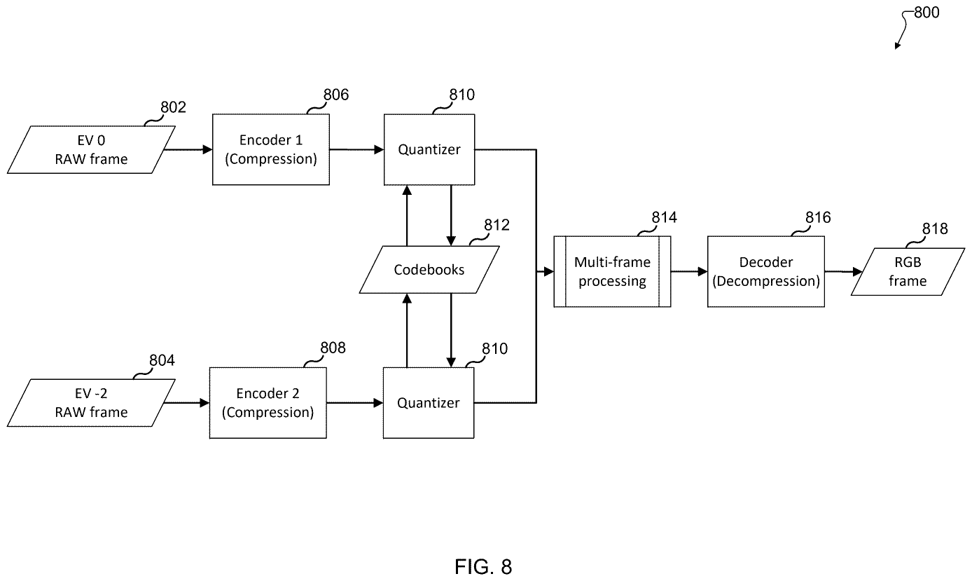

FIG. 8 illustrates an example compression system 800 for HDR processing in accordance with this disclosure. The compression system 800 is a modification of the compression system 700 of FIG. 7 for cases involving HDR processing. In such cases, the input frames are captured with different exposure values (EVs). For each different EV, a separate encoder can be trained to extract latent features from the input images, which allows for better encoding of the different EV images. At the same time, the latent feature sets output by each encoder can share the same latent space, which allows for MFP to be performed in the latent space. Additionally, the latent feature sets corresponding to the different EV images may be quantized using shared quantization codebooks.

As illustrated in FIG. 8, a raw frame 802 is captured with an EV of 0, while a raw frame 804 is captured with an EV of −2. A first encoder 806 is used to compress the EV0 image data into the latent space, and a second encoder 808 is used to compress the EV-2 image data into the same latent space. The latent feature sets generated by the encoders may each be quantized for storage with a quantizer 810 using codebooks 812. When image processing is to be performed, the quantized latent feature sets may also be dequantized with the quantizer 810. Multi-frame processing 814 (such as operations 406-412) can be performed on the different EV latent feature sets to generate a blended latent feature set, and a decoder 816 can be used to decompress the blended latent feature set to obtain an output RGB frame 818.

Although FIG. 8 illustrates one example of a compression system 800 for HDR processing, various changes may be made to FIG. 8. For example, various components, operations, or functions in FIG. 8 may be combined, further subdivided, replicated, omitted, or rearranged and additional components, operations, or functions may be added according to particular needs. Also, while FIG. 8 is illustrated with only two different EV frames, it will be understood that the compression system 800 may be adapted for any number of frames having different EVs.

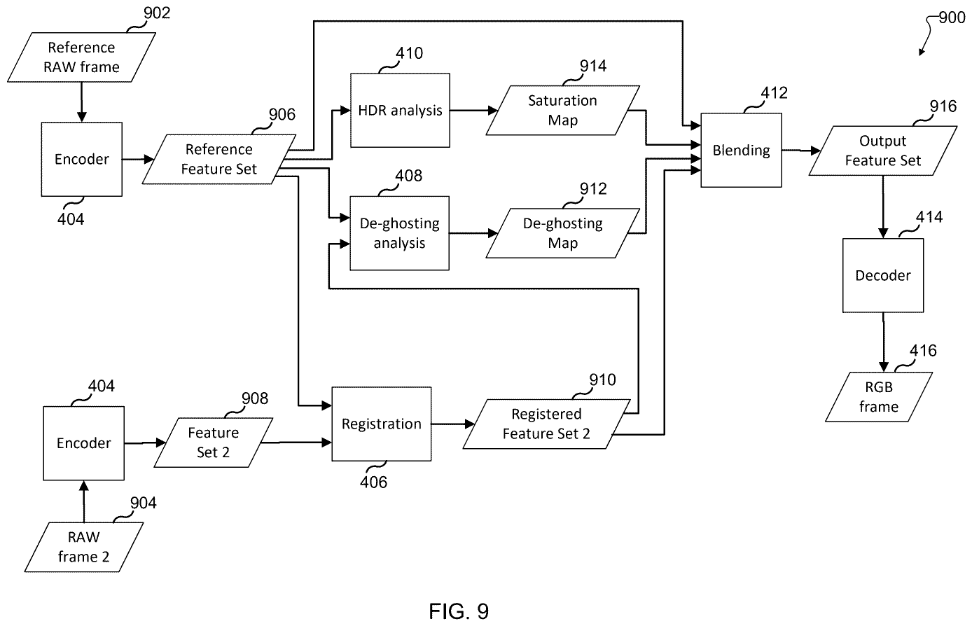

FIG. 9 illustrates another example MFP pipeline 900 in accordance with this disclosure. The MFP pipeline 900 may, for example, be an implementation of the improved MFP pipeline 400 of FIG. 4. For ease of explanation, the MFP pipeline 900 is described as being implemented using the electronic device 101 in the network configuration 100 of FIG. 1. However, the MFP pipeline 900 may be used with any other suitable device(s), such as the server 106, and in any other suitable system(s).

As illustrated in FIG. 9, the MFP pipeline 900 obtains full-resolution raw image space data of multiple raw input frames, such as raw frames 902 and 904. The raw frames 902 and 904 are encoded by an encoder corresponding to compression 404 to compress their raw image space data into latent feature sets 906 and 908 in the latent space. The encoder and the decoder (corresponding to decompression 414) may be implemented according to the example compression system 500 of FIG. 5 or the example compression system 600 of FIG. 6. These encoder/decoder networks can be trained to encode from a raw image space and decode into a color space, which implicitly accomplishes demosaicing in the MFP pipeline 900.

In embodiments involving HDR processing, each raw input frame may be captured with a different EV, and a separate encoder may be used for each different EV input frame. In embodiments without HDR, one encoder may be shared by all of the raw input frames. In either case, all further processing performed by the MFP pipeline 900 can occur in the latent space (such as the compressed domain).

In this example, one of the input frames is a reference raw frame 902, and its corresponding latent feature set is a reference latent feature set 906. The second raw frame 904 has a corresponding latent feature set 908. While FIG. 9 is illustrated with only two raw input frames, it will be understood that the MFP pipeline 900 may be adapted for any number of raw input frames. Additional raw input frames can be treated in the same manner as the second raw frame 904 for the purposes of the discussion below.

Image registration 406 is performed on the latent feature set 908 to compensate for motion of the capturing camera(s) or changing scene dynamics between capture of the reference raw frame 902 and the second raw frame 904. For example, the latent feature set 908 can be warped to match the framing of the reference latent feature set 906, resulting in registered latent feature set 910. Details of the image registration 406 are discussed further below with respect to FIG. 10.

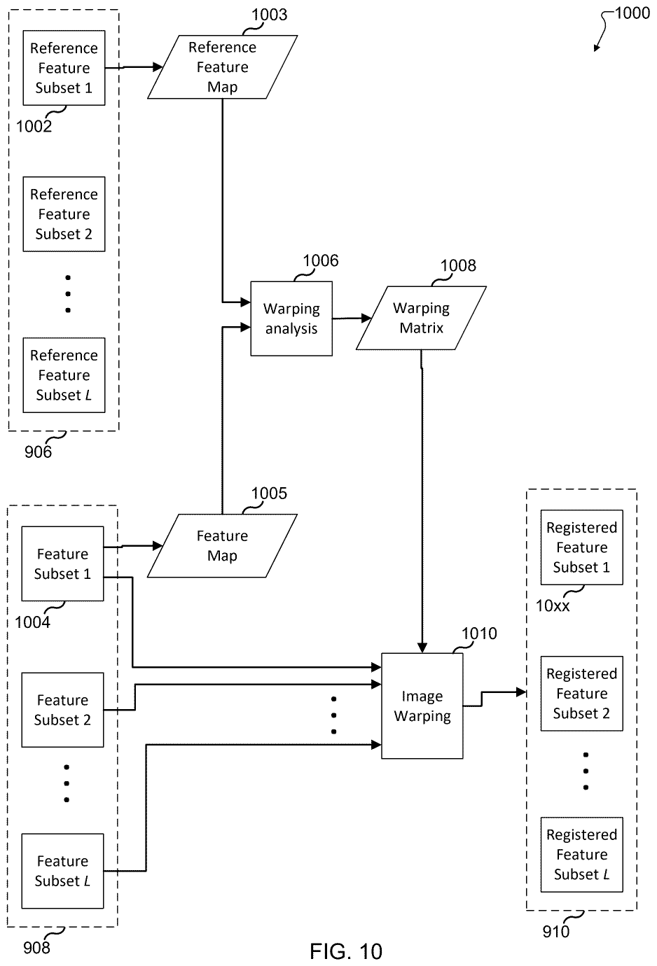

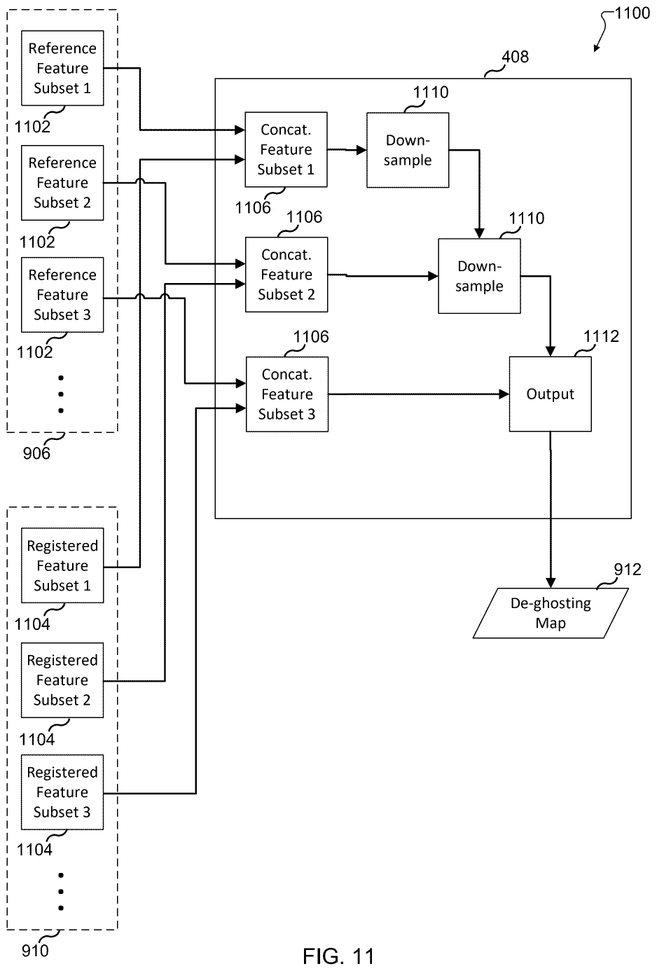

Deghosting analysis 408 is performed on the reference latent feature set 906 and the registered latent feature set 910 to detect incorrect registration or object motion between the capture of the reference raw frame 902 and the second raw frame 904. The deghosting analysis 408 results in a deghosting map 912 that is used to perform deghosting blending in the blending 412. Details of the deghosting analysis 408 are discussed further below with respect to FIG. 11.

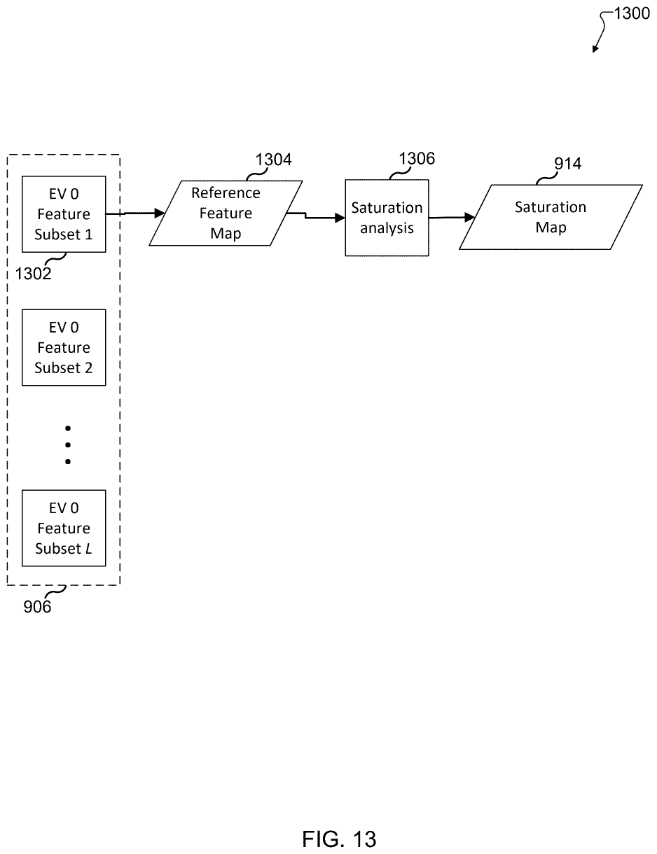

In embodiments with HDR processing, HDR analysis 410 is performed on the reference latent feature set 906 to detect oversaturated regions of the reference raw frame 902, which corresponds to the highest EV input frame. The HDR analysis 410 results in a saturation map 914 that is used to perform HDR blending in the blending 412. Details of the HDR analysis 410 are discussed further below with respect to FIG. 13.

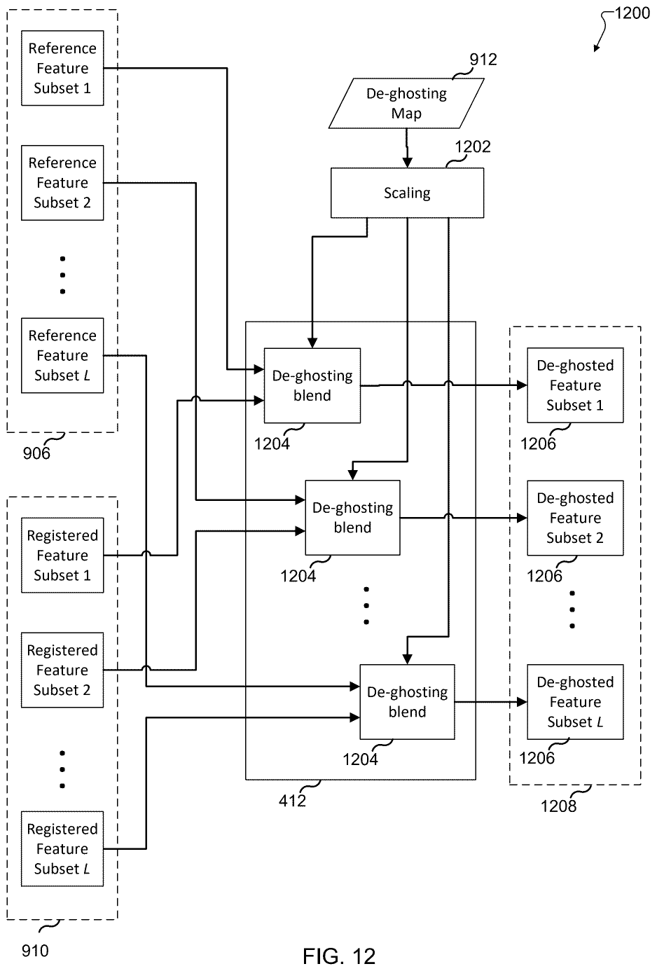

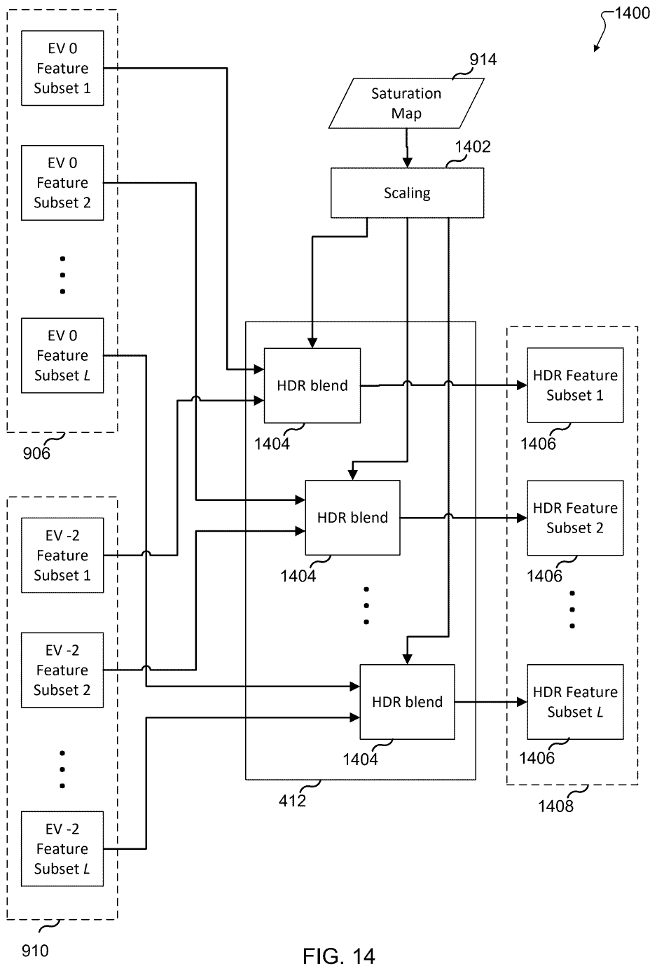

Blending 412 is performed on the reference latent feature set 906 and the registered latent feature set 910 using the deghosting map 912 and, if applicable, the saturation map 914. Blending 412 reduces noise in the output frame by blending the latent feature sets corresponding to multiple input frames. The deghosting map 912 facilitates this by indicating where blending should be avoided due to object motion between the input frames, as discussed further below with respect to FIG. 12. In embodiments with HDR processing, blending 412 also improves the apparent EV of the output frame by merging portions of input frames with different EVs. The saturation map 914 facilitates this by indicating where blending should be avoided due to oversaturation in the highest EV input frame, as discussed further below with respect to FIG. 14. Blending 412 results in an output latent feature set 916 that represents a blended output frame in the latent space.

The decoder corresponding to decompression 414 decompresses the output latent feature set 916 into the output RGB frame 416 in the pixel space. The RGB frame 416 is a blended output frame that receives the benefits of MFP but with significantly lower computation and memory demands on the processing device as compared to image-domain MFP techniques.

Although FIG. 9 illustrates another example of an MFP pipeline 900, various changes may be made to FIG. 9. For example, various components, operations, or functions in FIG. 9 may be combined, further subdivided, replicated, omitted, or rearranged and additional components, operations, or functions may be added according to particular needs. As a specific example, any number of raw frames 902, 904 may be input to the MFP pipeline 900 for processing in order to produce any number of output frames. Also, while specific color spaces like RGB are described above, image data in any other suitable color space(s) may be used.

FIG. 10 illustrates an example image registration operation 1000 in accordance with this disclosure. The image registration operation 1000 may, for example, be an implementation of the image registration 406 of FIGS. 4 and 9. The image registration operation 1000 analyzes the latent space representations of multiple frames and warps one to match another, compensating for motion of the capture device (such as a camera) or a change in scene dynamics between capture of the frames. In this example the image registration operation 1000 warps the latent feature set 908 to match the reference latent feature set 906. However, it will be understood that the image registration operation 1000 may be repeated for any number of additional latent feature sets representing additional raw input frames in the MFP pipeline 900 of FIG. 9.

The 2D latent feature maps that include the latent feature subsets resemble a low-resolution greyscale version of the input image from which they were encoded. These image-like feature maps may be used for numerous image analysis tasks, such as image segmentation and detection. In this case, the image registration operation 1000 may apply various image warping methods (such as homography transformation, elastic warping, or learning-based warping) to latent feature maps as if they were greyscale images. As shown in FIG. 10, the image registration operation 1000 selects one latent feature map from each latent feature set 906 and 908. In this example, the reference latent feature map 1003 is selected from the highest-layer reference latent feature subset 1002 of reference latent feature set 906, and latent feature map 1005 is selected from the highest-layer latent feature subset 1004 of latent feature set 908.

The image registration operation 1000 performs a warping analysis 1006 on the selected latent feature maps 1003 and 1005 as if they were greyscale images to generate a warping matrix 1008. The warping analysis 1006 may be, for example, a homography analysis using scale-invariant feature transform (SIFT) features, which generates a homography transformation matrix as the warping matrix 1008. Image warping 1010 is performed on each latent feature map in the latent feature set 908 using the warping matrix 1008. This warps the latent feature set 908 to match the reference latent feature set 906, resulting in the registered latent feature set 910. The reference latent feature set 906 and the registered latent feature set 910 are said to be registered with respect to each other.

Although FIG. 10 illustrates one example of an image registration operation 1000, various changes may be made to FIG. 10. For example, various components, operations, or functions in FIG. 10 may be combined, further subdivided, replicated, omitted, or rearranged and additional components, operations, or functions may be added according to particular needs. Also, other techniques for image registration may be used here.

FIG. 11 illustrates an example deghosting analysis operation 1100 in accordance with this disclosure. The deghosting analysis operation 1100 may, for example, be an implementation of the deghosting analysis 408 of FIGS. 4 and 9. Deghosting blending aims to blend two or more frames to reduce noise (such as noise due to ghosting effects) in the resulting blended frame. To achieve this in the latent space, the deghosting analysis operation 1100 uses latent features from the registered latent feature sets (906 and 910) to estimate a deghosting map 912 that indicates areas in which there is object motion between the input frames that correspond to the registered feature sets. In some cases, the deghosting map 912 may contain values in the range of [0,1], where a 0 represents no motion in the corresponding area and a 1 indicates strong motion in the area. In some embodiments, the deghosting map 912 may contain only binary values and simply represents whether there is any motion in each corresponding area.

As shown in FIG. 11, the deghosting analysis operation 1100 takes in the three highest-layer latent feature subsets 1102 from the reference latent feature set 906 and the three highest-layer latent feature subsets 1104 from the registered latent feature set 910. Each pair of matching spatial dimension subsets can be concatenated to form a concatenated latent feature subset 1106 that has the same spatial dimension and double the feature channels. Using the example of Table 1 above for 512× 512× 1 raw input frames, the three highest-layer feature subsets (from both latent feature sets 906 and 910) have sizes 256×256×32, 128×128×64, and 64×64× 128, respectively. The corresponding concatenated latent feature subsets 1106 thus have sizes 256×256×64, 128×128×128, and 64×64×256, respectively.

The concatenated latent feature subsets 1106, which are 3D matrices, are input to a deghosting network that includes two down-sample layers 1110 and an output layer 1112 as shown in FIG. 11. In some cases, each of the layers 1110 and 1112 may be a convolutional layer. Continuing with the example sizes from Table 1, the output of the first down-sample layer 1110 has size 128×128×64, the output of the second down-sample layer 1110 has size 64×64×128, and the output of the output layer 1112 (which is the estimated deghosting map 912) has size 64×64×1.

Although FIG. 11 illustrates one example of a deghosting analysis operation 1100, various changes may be made to FIG. 11. For example, various components, operations, or functions in FIG. 11 may be combined, further subdivided, replicated, omitted, or rearranged and additional components, operations, or functions may be added according to particular needs. Also, other techniques for deghosting analysis may be used here.

FIG. 12 illustrates an example deghosting blending operation 1200 in accordance with this disclosure. The deghosting blending operation 1200 may, for example, be an implementation of the blending 412 of FIGS. 4 and 9. The deghosting blending operation 1200 uses the estimated deghosting map 912 generated by the deghosting analysis operation 1100 to blend latent features of the reference latent feature set 906 and the registered latent feature set 910 together to reduce noise, which can also include avoiding blending areas in which there is object motion between frames.

As shown in FIG. 12, the deghosting blending operation 1200 performs scaling operation 1202 to match the spatial dimensions of the deghosting map 912 to the spatial dimensions of each latent feature subset before blending. Using the example of Table 1 above, the highest-layer feature subsets have spatial dimensions of 256×256, the lowest-layer feature subsets have spatial dimensions of 4×4, and the deghosting map 912 has spatial dimensions of 64×64. Accordingly, the deghosting map 912 can be scaled up for blending with some feature subsets and scaled down for blending with others. The scaling operation 1202 may, for example, be achieved via image resizing with bicubic interpolation. An appropriately-scaled deghosting map can be applied by the corresponding deghosting blending block 1204 to blend the corresponding spatial dimensions of latent feature subsets from the reference latent feature set 906 and the registered latent feature set 910 together, resulting in a deghosted latent feature subset 1206 with the corresponding spatial dimensions. Equation (1) describes one example method for blending the latent feature subsets.

$${F}^{i} = {F}_{1}^{i} \times \frac{( 1 + {DeghostMap}^{i} )}{2} + {F}_{2}^{i} \times \frac{( 1 - {DeghostMap}^{i} )}{2} \qquad ( 1 )$$

In Equation (1), Fⁱ represents the i^{th} deghosted (blended) latent feature subset 1206, for i∈[1, L]. Also, F₁ⁱ represents the i^{th} latent feature subset from the reference latent feature set 906, and

$${F}_{2}^{i}$$

represents the i^{th} latent feature subset from the registered latent feature set 910. DeghostMapⁱ represents the scaled deghosting map, which has the same spatial dimensions as the i^{th} latent feature subsets

$${F}_{1}^{i} and {F}_{2}^{i} .$$

Once all L deghosted latent feature subsets 1206 are generated, they may form deghosted latent feature subset 1208. In some embodiments, this may be the output latent feature set 916 of FIG. 9 (such as when no HDR blending is needed).

The function of Equation (1) provides a weighted average of two latent feature subsets where the scaled deghosting map has a value less than 1 (indicating no motion or low motion between the frames) and retains the value of the reference latent feature subset when the scaled deghosting map has a value of 1 (indicating strong motion between the frames). In other cases, if the deghosting map 912 is a binary motion map, Equation (1) may simply average the two latent feature subsets when the value of the deghosting map is 0 (indicating no motion between the frames) and retain the value of the reference latent feature subset when the value of the deghosting map is 1 (indicating motion between the frames). Although this example blends only two latent feature sets (corresponding to two raw input frames), it will be understood that Equation (1) can be adjusted to account for blending any number of input latent feature sets (corresponding to any number of raw input frames).

Although FIG. 12 illustrates one example of a deghosting blending operation 1200, various changes may be made to FIG. 12. For example, various components, operations, or functions in FIG. 12 may be combined, further subdivided, replicated, omitted, or rearranged and additional components, operations, or functions may be added according to particular needs. Also, other techniques for deghosting blending may be used here.

FIG. 13 illustrates an example HDR analysis operation 1300 in accordance with this disclosure. The HDR analysis operation 1300 may, for example, be an implementation of the HDR analysis 410 of FIGS. 4 and 9. HDR blending aims to blend two or more frames with different EVs to improve the overall exposure of the resulting blended frame. To achieve this in the latent space, the HDR analysis operation 1300 generates a saturation map that indicates oversaturated regions of the reference latent feature set 906, which corresponds to the EV0 frame in the case of HDR blending.

Similar to the image registration operation 1000 of FIG. 10, the HDR analysis operation 1300 treats a latent feature map from the reference latent feature set 906 as a greyscale image for the purposes of generating the saturation map. For example, the HDR analysis operation 1300 selects a reference latent feature map 1304 from the highest-layer latent feature subset 1302 of the reference latent feature set 906, performs saturation analysis 1306 on the selected feature map to generate a saturation map 914. The saturation analysis 1306 may involve applying a saturation threshold to the selected feature map to determine areas of the feature map in which the corresponding EV0 input image is oversaturated. The saturation map 914 may be a binary map that has a value of 1 in areas in which the corresponding image is oversaturated.

Although FIG. 13 illustrates one example of an HDR analysis operation 1300, various changes may be made to FIG. 13. For example, various components, operations, or functions in FIG. 13 may be combined, further subdivided, replicated, omitted, or rearranged and additional components, operations, or functions may be added according to particular needs. Also, other techniques for HDR analysis may be used here.

FIG. 14 illustrates an example HDR blending operation 1400 in accordance with this disclosure. The HDR blending operation 1400 may, for example, be an implementation of the blending 412 of FIGS. 4 and 9. The HDR blending operation 1400 uses the saturation map 914 generated by the HDR analysis operation 1300 to blend latent features of the reference latent feature set 906 and the registered latent feature set 910 together to improve the exposure of the blended frame. In this example, the reference latent feature set 906 corresponds to the EV0 input frame, and the registered latent feature set 910 corresponds to the EV-2 input frame.

As shown in FIG. 14, the HDR blending operation 1400 performs scaling operation 1402 to match the spatial dimensions of the saturation map 914 to the spatial dimensions of each latent feature subset before blending. Using the example of Table 1 above, the highest-layer feature subsets have spatial dimensions of 256×256, while the lowest-layer feature subsets have spatial dimensions of 4×4. As the saturation map 914 was generated from a feature map from the highest-layer feature subset, it also has spatial dimensions of 256×256, but it can be scaled down for blending with the lower-layer feature subsets. The scaling operation 1402 may, for example, be achieved via image resizing with bicubic interpolation. An appropriately-scaled saturation map can be applied by the corresponding HDR blending block 1404 to blend the corresponding spatial dimensions of latent feature subsets from the reference latent feature set 906 and the registered latent feature set 910 together, resulting in an HDR blended latent feature subset 1406 with the corresponding spatial dimensions. Equation (2) describes one example method for blending the latent feature subsets.

$${F}^{i} = {F}_{ev 0}^{i} \times ( 1 - Gaussian ( {SatMap}^{i} ) ) + {F}_{ev - 2}^{i} \times Gaussian ( {SatMap}^{i} ) \qquad ( 2 )$$

In Equation (2), Fⁱ represents the i^{th} HDR blended latent feature subset 1406, for i∈[1, L]. Also,

$${F}_{e v 0}^{i}$$

represents the i^{th} latent feature subset from the reference latent feature set 906 (the EV0 latent feature set), and

$${F}_{e v - 2}^{i}$$

represents the i^{th} latent feature subset from the registered latent feature set 910 (the EV-2 latent feature set). SatMapⁱ represents the scaled saturation map, which has the same spatial dimensions as the i^{th} latent feature subsets

$${F}_{e v 0}^{i} and {F}_{e v - 2}^{i} .$$

The Gaussian ( ) function represents Gaussian blurring, which is used to create a soft boundary and avoid boundary artifacts. Once all L HDR blended latent feature subsets 1406 are generated, they may form HDR blended latent feature subset 1408. In some embodiments, this may be the output latent feature set 916 of FIG. 9.

Although FIG. 14 illustrates one example of an HDR blending operation 1400, various changes may be made to FIG. 14. For example, various components, operations, or functions in FIG. 14 may be combined, further subdivided, replicated, omitted, or rearranged and additional components, operations, or functions may be added according to particular needs. Also, other techniques for HDR blending may be used here.

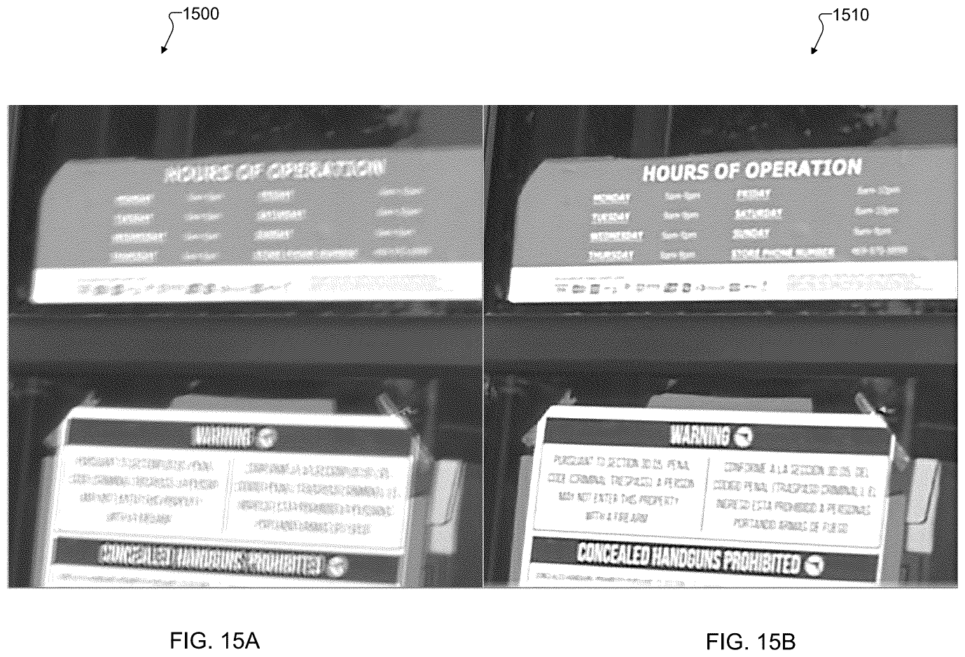

FIGS. 15A-15B illustrate an example comparison between an image 1500 generated without image registration and an image 1510 generated with image registration in the compressed domain in accordance with this disclosure. In this example, the images 1500 and 1510 are generated from the same captured frame of a scene. As can be seen here, performing image registration in the compressed domain notably reduces blurriness in the image 1510 as compared to the image 1500.

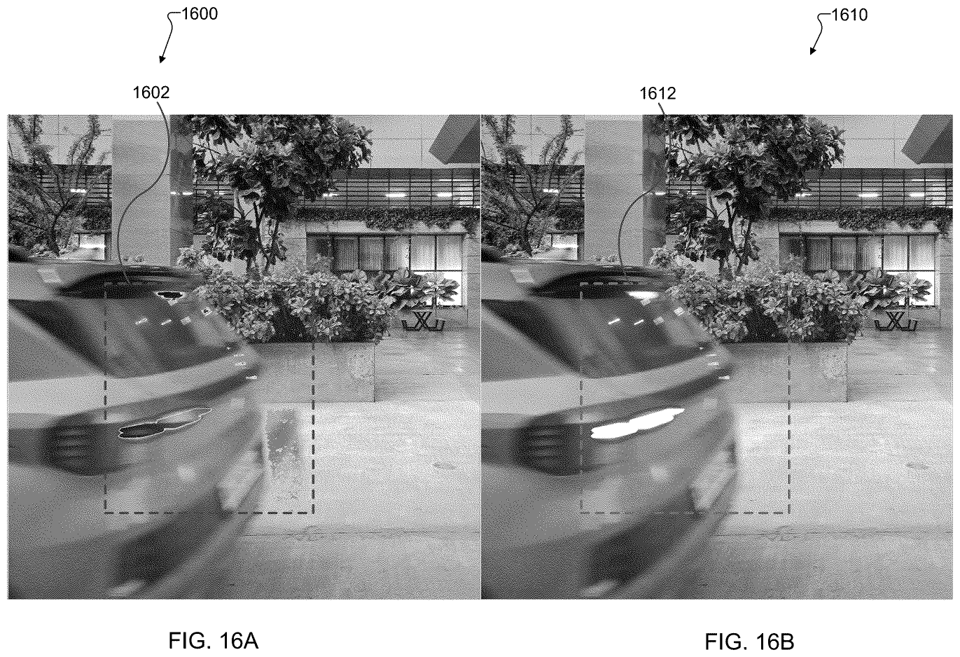

FIGS. 16A-16B illustrate an example comparison of ghosting artifacts between an image 1600 generated without deghosting and an image 1610 generated with deghosting in the compressed domain in accordance with this disclosure. In this example, the images 1600 and 1610 are generated from the same captured frame of a scene, and similar areas of each image are highlighted for comparison. Specifically, an area 1602 of the image 1600 may be compared to an area 1612 of the image 1610. As can be seen here, there is a notable reduction in ghosting (or motion) artifacts in the image 1610 as compared to the image 1600.

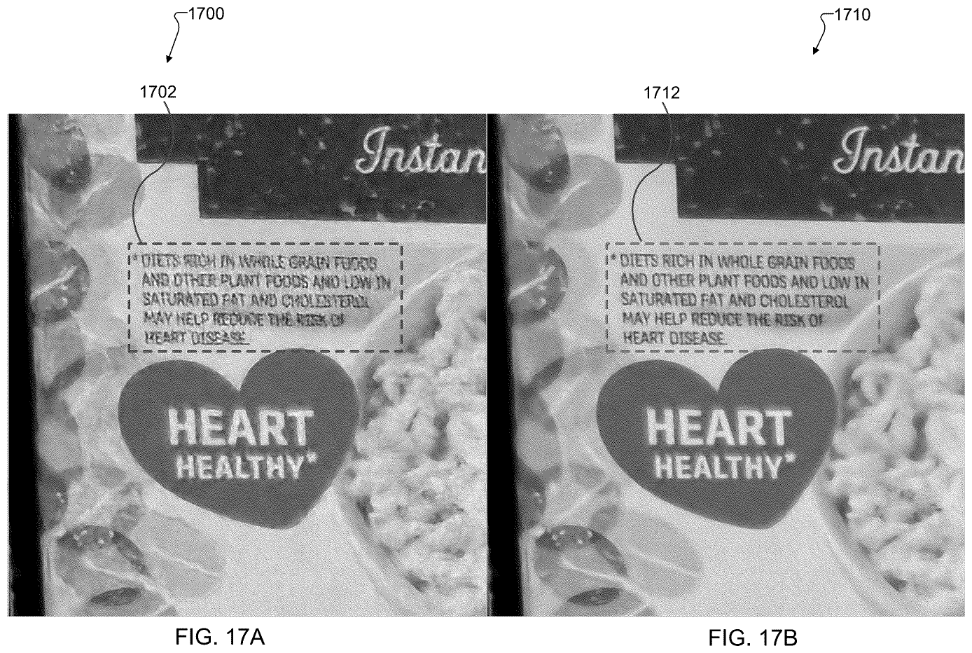

FIGS. 17A-17B illustrate an example comparison of noise between an image 1700 generated without multi-frame blending and an image 1710 generated with multi-frame blending in the compressed domain in accordance with this disclosure. In this example, the image 1710 is generated from a multi-frame capture of a scene and is the result of image registration, deghosting, and blending performed in the compressed domain. The image 1700, meanwhile, is generated from a single one of the captured frames. Similar areas of each image are highlighted for comparison. Specifically, an area 1702 of the image 1700 may be compared to an area 1712 of the image 1710. As can be seen here, there is a notable reduction in noise in the image 1710 as compared to the image 1700.

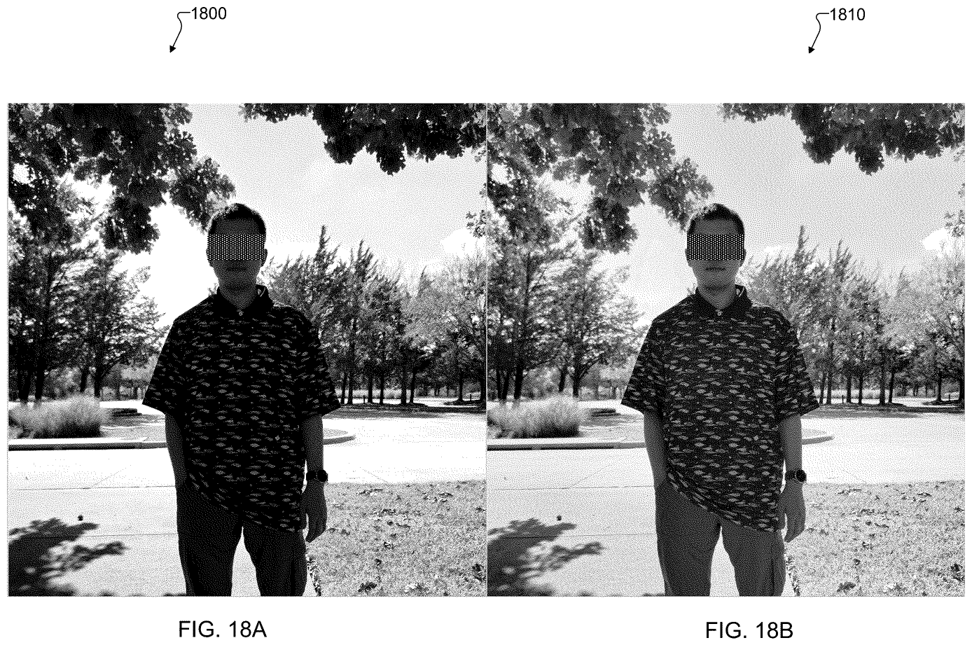

FIGS. 18A-18B illustrate an example comparison between an image 1800 generated without HDR blending and an image 1810 generated with HDR blending in the compressed domain in accordance with this disclosure. In this example, the images 1800 and 1810 are generated from the same multi-frame capture of a scene. The image 1800 is generated through MFP without HDR blending, while the image 1810 is generated through MFP with HDR blending in the compressed domain. As can be seen here, there is a notable improvement in the exposure level and visible detail in the image 1810 as compared to the image 1800.

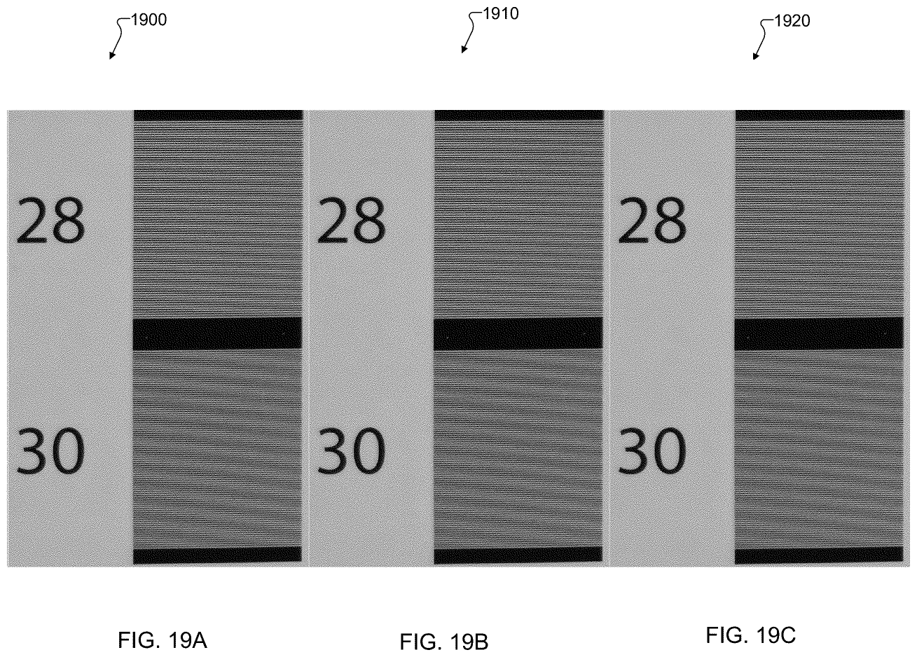

FIGS. 19A-19C illustrate an example comparison between an image 1900 generated after encoding, an image 1910 generated after encoding with quantization, and a ground truth image 1920 in accordance with this disclosure. In this example, the images 1900, 1910, and 1920 are generated from the same raw frame of a scene. The image 1900 is reconstructed from the raw frame data after encoding into a continuous latent space according to embodiments discussed in the present disclosure. The image 1910 is reconstructed from the raw frame data after encoding into the continuous latent space and quantization into a discrete latent space according to embodiments discussed in the present disclosure. The ground truth image 1920 is generated from the raw frame data without any compression. As compared to the ground truth image 1920, the image 1900 has a peak signal-to-noise ratio (PSNR) of 47.26 dB and a structural similarity index measure (SSIM) of 0.9981, while the image 1920 has a PSNR of 45.94 dB and an SSIM of 0.9973. This indicates that the encoding and quantization procedures of the present disclosure are visually lossless. As can be seen here, the image 1910 is nearly identical to the images 1900 and 1920.

Although FIGS. 15A-19C illustrate examples of comparisons between images with and without compressed-domain multi-frame processing, various changes may be made to FIGS. 15A-19C. For example, the results in FIGS. 15A-19C are merely meant to illustrate examples of types of benefits that might be obtained using the techniques of this disclosure. The specific results that are obtained in any given situation can vary based on the circumstances and based on the specific implementation of the techniques described in this disclosure.

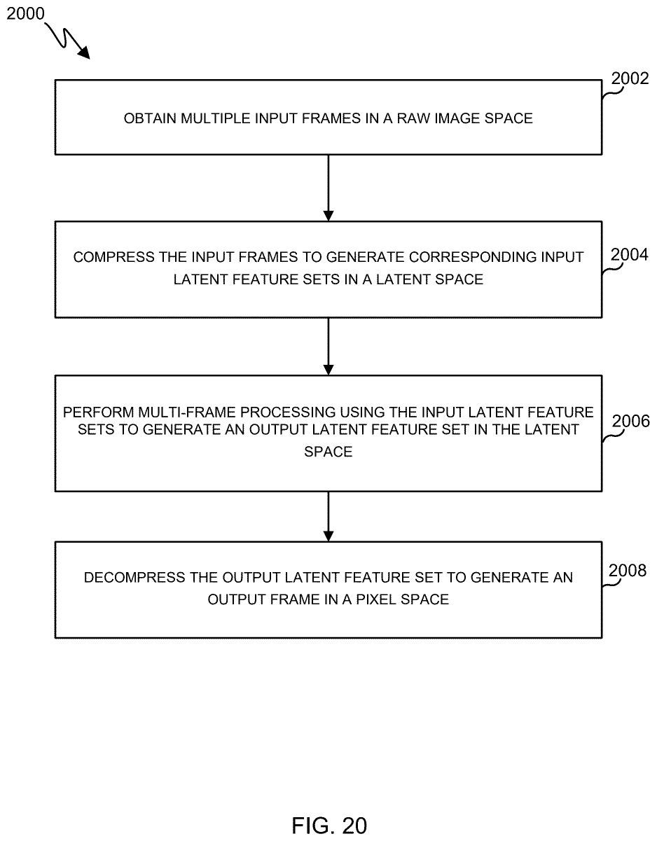

FIG. 20 illustrates an example method 2000 for compressed-domain multi-frame image processing in accordance with this disclosure. For ease of explanation, the method 2000 shown in FIG. 20 is described as being performed using the electronic device 101 in the network configuration 100 of FIG. 1, where the electronic device 101 can implement the compressed-domain multi-frame image processing system 200 of FIG. 2. However, the method 2000 could be performed using any other suitable device(s), such as the server 106, and in any other suitable system(s).

As shown in FIG. 20, the electronic device 101 obtains multiple input frames in a raw image space at step 2002. In some cases, the input video frames may be obtained using one or more cameras or other imaging sensors 180 or the image input device 206 in the electronic device 101, obtained from a previously-captured multi-frame image set stored in memory 130, or obtained in any other suitable manner.

The input frames are compressed to generate corresponding input latent feature sets in a latent space at step 2004. In some embodiments, each input latent feature set includes multiple input latent feature subsets. For each input latent feature set, each of the input latent feature subsets has a different spatial dimension and includes multiple feature maps having the spatial dimension of the subset. In some cases, the processor 120 of the electronic device 101 may compress the input frames by encoding the input frames using an AI/ML model (such as the trained frame compression model 202 of FIG. 2) to generate the corresponding input latent feature sets in the latent space. Also, in some cases, the processor 120 may perform the compression 404 or implement the encoders 806/808 of FIGS. 4-9 using one of the compression systems 500, 600, or 700 of FIGS. 5-7.

In some embodiments, the input latent feature sets are continuous latent feature sets, and the latent space is a continuous latent space. The processor 120 of the electronic device 101 may compress each input latent feature set to generate a corresponding discrete input latent feature set in a discrete latent feature space by quantization of each of the continuous input latent feature subsets using a corresponding quantization codebook to generate a corresponding discrete input latent feature subset in the discrete latent feature space and decompress, before the multi-frame processing, each discrete input latent feature set to generate the corresponding input latent feature set by de-quantization of each of the discrete input latent feature subsets using the corresponding quantization codebook to generate the corresponding continuous input latent feature subset in the continuous latent space. In some embodiments, the processor 120 may perform quantization as part of the compression 404 or the implementation of encoder 806/808 of FIGS. 4-9 using the compression system 700 of FIG. 7. The quantization may represent a vector quantization, and the de-quantization may represent a vector de-quantization. Here, the processor 120 may perform the quantization and de-quantization using an AI/ML model (such as the trained compressed-domain quantization model 203 of FIG. 2).

Multi-frame processing is performed using the input latent feature sets to generate an output latent feature set in the latent space at step 2006. In some cases, the processor 120 of the electronic device 101 may perform registration on the input latent feature sets in the latent space to generate registered feature sets and perform deghosting on the registered feature sets in the latent space to generate a blended feature set using a second AI/ML model (such as the trained compressed-domain deghosting analysis model 204 of FIG. 2).

In some embodiments, the registration performed on the input latent feature sets in the latent space can be done by selecting a reference feature map from one of the input latent feature sets that corresponds to a reference frame of the input frames. For each other input latent feature set, a feature map having a spatial dimension that matches a spatial dimension of the reference feature map can be selected. A warping matrix can be generated from the selected feature map and the reference feature map, and each feature map of the input latent feature subsets can be warped using the warping matrix. In some cases, the processor 120 may perform the registration 406 of FIGS. 4 and 9 using the image registration operation 1000 of FIG. 10.

In some embodiments, each registered feature set includes multiple registered feature subsets. The deghosting performed in the latent space using the second AI/ML model can be done by estimating, based on at least some of the registered feature subsets having highest spatial dimensions from each of the registered feature sets, a deghosting motion map that indicates portions of the registered feature sets in which there is motion between the input frames. For each spatial dimension of the registered feature subsets, the deghosting motion map can be scaled to that spatial dimension, and deghosting blending can be performed on the registered feature subsets having that spatial dimension according to the scaled deghosting blending map to generate a deghosted feature subset having that spatial dimension. Here, the blended feature set may include the deghosted feature subsets. In some cases, the processor 120 may perform the deghosting analysis 408 and blending 412 of FIGS. 4 and 9 using the deghosting analysis operation 1100 of FIG. 11 and the deghosting blending operation 1200 of FIG. 12.

In some embodiments, each of the multiple input frames is captured with a different EV, and the input frame captured with a highest EV is considered the reference frame. Here, the processor 120 of the electronic device 101 may perform HDR blending in the latent space as part of the multi-frame processing in the latent space. The HDR blending may be performed by selecting a reference feature map from one of the input latent feature sets that corresponds to the reference frame. A saturation map can be generated that indicates portions of the reference feature map in which saturation is above a specified threshold. For each spatial dimension of the deghosted feature subsets, the saturation map can be scaled to that spatial dimension, and HDR blending can be performed on the deghosted feature subsets having that spatial dimension according to the scaled saturation map to generate an HDR blended feature subset having that spatial dimension. In some cases, the processor 120 may perform the HDR analysis 410 and blending 412 of FIGS. 4 and 9 using the HDR analysis operation 1300 of FIG. 13 and the HDR blending operation 1400 of FIG. 14.

The output latent feature set is decompressed to generate an output frame in a pixel space at step 2008. In some embodiments, the output latent feature set includes multiple output latent feature subsets, and each output latent feature subset has a different spatial dimension and includes multiple feature maps having the spatial dimension of the subset. Here, processor 120 of the electronic device 101 may decompress the output latent feature set by decoding, using the compression AI/ML model (such as the trained frame compression model 202 of FIG. 2), the output latent feature subsets to generate the output frame in the pixel space. In some cases, the processor 120 may perform the decompression 414 or implement the decoder 816 of FIG. 4-9 using one of the compression systems 500, 600, or 700 of FIGS. 5-7. Also, in some cases, the input frames may have a first resolution. The processor 120 may decompress the output latent feature set to generate the output frame in the pixel space at the first resolution, or the processor 120 may decompress the output latent feature set to generate the output frame in the pixel space at a second resolution that is lower than the first resolution.

Although FIG. 20 illustrates one example of a method 2000 for compressed-domain multi-frame image processing, various changes may be made to FIG. 20. For example, while shown as a series of steps, various steps in FIG. 20 could overlap, occur in parallel, occur in a different order, or occur any number of times (including zero times).

It should be noted that the functions shown in or described with respect to FIGS. 2 through 20 can be implemented in an electronic device 101, 102, 104, server 106, or other device(s) in any suitable manner. For example, in some embodiments, at least some of the functions shown in or described with respect to FIGS. 2 through 20 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 20 can be implemented or supported using dedicated hardware components. In general, the functions shown in or described with respect to FIGS. 2 through 20 can be performed using any suitable hardware or any suitable combination of hardware and software/firmware instructions. Also, the functions shown in or described with respect to FIGS. 2 through 20 can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, multiple input frames in a raw image space;
compressing, using the at least one processing device, the input frames to generate corresponding input latent feature sets in a latent space;
performing, using the at least one processing device, multi-frame processing using the input latent feature sets to generate an output latent feature set in the latent space; and
decompressing, using the at least one processing device, the output latent feature set to generate an output frame in a pixel space.

2. The method of claim 1, wherein:
compressing the input frames comprises encoding, using a machine learning model, the input frames to generate the corresponding input latent feature sets in the latent space;
each input latent feature set comprises multiple input latent feature subsets; and
for each input latent feature set, each of the input latent feature subsets has a different spatial dimension and comprises multiple feature maps having the spatial dimension of the subset.

3. The method of claim 2, wherein:
the latent space comprises a continuous latent space;
the input latent feature subsets are continuous input latent feature subsets; and
the method further comprises:
compressing each input latent feature set to generate a corresponding discrete input latent feature set in a discrete latent feature space by quantizing each of the continuous input latent feature subsets using a corresponding quantization codebook to generate a corresponding discrete input latent feature subset in the discrete latent feature space; and
before performing the multi-frame processing, decompressing each discrete input latent feature set to generate the corresponding input latent feature set by de-quantizing each of the discrete input latent feature subsets using the corresponding quantization codebook to generate the corresponding continuous input latent feature subset in the continuous latent space.

4. The method of claim 2, wherein:
the output latent feature set comprises multiple output latent feature subsets;
each output latent feature subset has a different spatial dimension and comprises multiple feature maps having the spatial dimension of the subset; and
decompressing the output latent feature set comprises decoding, using the machine learning model, the output latent feature subsets to generate the output frame in the pixel space.

5. The method of claim 4, wherein:
the input frames have a first resolution; and
decompressing the output latent feature set comprises decoding, using the machine learning model, the output latent feature subsets to generate the output frame in the pixel space at the first resolution.

6. The method of claim 4, wherein:
the input frames have a first resolution;
decompressing the output latent feature set comprises decoding, using the machine learning model, some of the output latent feature subsets to generate the output frame in the pixel space at a second resolution; and
the second resolution is lower than the first resolution.

7. The method of claim 2, wherein performing the multi-frame processing in the latent space comprises:
performing registration on the input latent feature sets in the latent space to generate registered feature sets; and
performing, using a second machine learning model, deghosting on the registered feature sets in the latent space to generate a blended feature set.

8. The method of claim 7, wherein performing the registration comprises:
selecting a reference feature map from one of the input latent feature sets that corresponds to a reference frame of the input frames; and
for each other input latent feature set:
selecting a feature map having a spatial dimension that matches a spatial dimension of the reference feature map;
generating a warping matrix from the selected feature map and the reference feature map; and
warping each feature map of the input latent feature subsets using the warping matrix.

9. The method of claim 7, wherein:
each registered feature set comprises multiple registered feature subsets;
performing the deghosting comprises:
estimating, using the second machine learning model based on at least some of the registered feature subsets having highest spatial dimensions from each of the registered feature sets, a deghosting motion map that indicates portions of the registered feature sets in which there is motion between the input frames; and
for each spatial dimension of the registered feature subsets, scaling the deghosting motion map to that spatial dimension and performing deghosting blending on the registered feature subsets having that spatial dimension according to the scaled deghosting blending map to generate a deghosted feature subset having that spatial dimension; and
the blended feature set comprises the deghosted feature subsets.

10. The method of claim 9, wherein:
each of the multiple input frames is captured with a different exposure value (EV);
the input frame captured with a highest EV is a reference frame; and
performing the multi-frame processing in the latent space comprises:
selecting a reference feature map from one of the input latent feature sets that corresponds to the reference frame;
generating a saturation map that indicates portions of the reference feature map in which saturation is above a specified threshold; and
for each spatial dimension of the deghosted feature subsets, scaling the saturation map to that spatial dimension and performing high dynamic range (HDR) blending on the deghosted feature subsets having that spatial dimension according to the scaled saturation map to generate an HDR blended feature subset having that spatial dimension.

11. An electronic device comprising:
at least one processing device configured to:
obtain multiple input frames in a raw image space;
compress the input frames to generate corresponding input latent feature sets in a latent space;
perform multi-frame processing using the input latent feature sets to generate an output latent feature set in the latent space; and
decompress the output latent feature set to generate an output frame in a pixel space.

12. The electronic device of claim 11, wherein:
to compress the input frames, the at least one processing device is configured to encode, using a machine learning model, the input frames to generate the corresponding input latent feature sets in the latent space;
each input latent feature set comprises multiple input latent feature subsets; and
for each input latent feature set, each of the input latent feature subsets has a different spatial dimension and comprises multiple feature maps having the spatial dimension of the subset.

13. The electronic device of claim 12, wherein:
the latent space comprises a continuous latent space;
the input latent feature subsets are continuous input latent feature subsets; and
the at least one processing device is further configured to:
compress each input latent feature set to generate a corresponding discrete input latent feature set in a discrete latent feature space by quantization of each of the continuous input latent feature subsets using a corresponding quantization codebook to generate a corresponding discrete input latent feature subset in the discrete latent feature space; and
decompress, before the multi-frame processing, each discrete input latent feature set to generate the corresponding input latent feature set by de-quantization of each of the discrete input latent feature subsets using the corresponding quantization codebook to generate the corresponding continuous input latent feature subset in the continuous latent space.

14. The electronic device of claim 12, wherein:
the output latent feature set comprises multiple output latent feature subsets;
each output latent feature subset has a different spatial dimension and comprises multiple feature maps having the spatial dimension of the subset; and
to decompress the output latent feature set, the at least one processing device is configured to decode, using the machine learning model, the output latent feature subsets to generate the output frame in the pixel space.

15. The electronic device of claim 14, wherein:
the input frames have a first resolution; and
to decompress the output latent feature set, the at least one processing device is configured to decode, using the machine learning model, the output latent feature subsets to generate the output frame in the pixel space at the first resolution.

16. The electronic device of claim 14, wherein:
the input frames have a first resolution;
to decompress the output latent feature set, the at least one processing device is configured to decode, using the machine learning model, some of the output latent feature subsets to generate the output frame in the pixel space at a second resolution; and
the second resolution is lower than the first resolution.

17. The electronic device of claim 12, wherein, to perform the multi-frame processing in the latent space, the at least one processing device is configured to:
perform registration on the input latent feature sets in the latent space to generate registered feature sets; and
perform, using a second machine learning model, deghosting on the registered feature sets in the latent space to generate a blended feature set.

18. The electronic device of claim 17, wherein, to perform the registration, the at least one processing device is configured to:
select a reference feature map from one of the input latent feature sets that corresponds to a reference frame of the input frames; and
for each other input latent feature set:
select a feature map having a spatial dimension that matches a spatial dimension of the reference feature map;
generate a warping matrix from the selected feature map and the reference feature map; and
warp each feature map of the input latent feature subsets using the warping matrix.

19. The electronic device of claim 17, wherein:
each registered feature set comprises multiple registered feature subsets;
to perform the deghosting, the at least one processing device is configured to:
estimate, using the second machine learning model based on at least some of the registered feature subsets having highest spatial dimensions from each of the registered feature sets, a deghosting motion map that indicates portions of the registered feature sets in which there is motion between the input frames; and
for each spatial dimension of the registered feature subsets, scale the deghosting motion map to that spatial dimension and perform deghosting blending on the registered feature subsets having that spatial dimension according to the scaled deghosting blending map to generate a deghosted feature subset having that spatial dimension; and
the blended feature set comprises the deghosted feature subsets.

20. The electronic device of claim 19, wherein:
each of the multiple input frames is captured with a different exposure value (EV);
the input frame captured with a highest EV is a reference frame; and
to perform the multi-frame processing in the latent space, the at least one processing device is configured to:
select a reference feature map from one of the input latent feature sets that corresponds to the reference frame;
generate a saturation map that indicates portions of the reference feature map in which saturation is above a specified threshold; and
for each spatial dimension of the deghosted feature subsets, scale the saturation map to that spatial dimension and perform high dynamic range (HDR) blending on the deghosted feature subsets having that spatial dimension according to the scaled saturation map to generate an HDR blended feature subset having that spatial dimension.
